(19) United States
(12) Patent Application Publication
(10) Pub. No.: US 2021/0379732 A1
(43) Pub. Date: Dec. 9, 2021

(54) ABRASIVE ARTICLE INCLUDING FLEXIBLE WEB

(71) Applicant: 3M INNOVATIVE PROPERTIES COMPANY, St. Paul, MN (US)

(72) Inventors: Yuyang Liu, St. Paul, MN (US); Daimon K Heller, Houlton, WI (US); David M. Wilson, Bloomington, MN (US)

(21) Appl. No.: 17/286,682

(22) PCT Filed: Oct. 22, 2019
(86) PCT No.: PCT/IB2019/059007

§ 371 Date: Apr. 19, 2021

Related U.S. Application Data
(60) Provisional application No. 62/751,097, filed on Oct. 26, 2018.

(51) Int. Cl. B24D 11/02; B24D 3/06; B24D 3/14

(52) U.S. Cl. CPC B24D 11/02; B24D 3/14; B24D 3/06

(57) ABSTRACT

Various embodiments disclosed relate to an abrasive article. The abrasive article includes a fibrous web comprising a plurality high-heat resistant fibers. The fibrous web further includes a plurality of shaped abrasive particles attached to the fibrous web.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, and ease of manufacturing abrasive articles.

### SUMMARY OF THE DISCLOSURE

Various embodiments disclosed relate to an abrasive article. The abrasive article includes a fibrous web comprising a plurality high-heat resistant fibers. The fibrous web further includes a plurality of shaped abrasive particles attached to the fibrous web.

Various embodiments disclosed further relate to a method of making an abrasive article. The method incudes contacting a fibrous web with a plurality of shaped abrasive particles to form an abrasive article precursor. The method further includes heating the abrasive article precursor to a temperature of at least about 800° C.

Various embodiments disclosed further relate a method of using an abrasive article. The abrasive article includes a fibrous web comprising a plurality high-heat resistant fibers. The fibrous web further includes a plurality of shaped abrasive particles attached to the fibrous web. The method includes contacting the abrasive article with a workpiece. The method further includes moving at least one of the abrasive article and the workpiece relative to each other. The method further includes removing at least a portion of the workpiece.

Various embodiments of the present disclosure provide various advantages, some of which are unexpected. For example, according to various embodiments, the fibrous web and shaped abrasive particles are capable of being exposed to high temperatures during firing and remain structurally intact. According to various embodiments, this can allow for a simple method to form abrasive articles having shaped abrasive particles arranged according to a predetermined pattern. For example, according to various embodiments, the shaped abrasive particles are disposed in a production tool having a plurality of cavities arranged in a pattern conforming to the desired predetermined pattern of the shaped abrasive particles. According to various embodiments, the shaped abrasive particles are attached to a fibrous backing, removed from the production tool, and fired. According to various embodiments, the fired fibrous backing and abrasive particles can be used as an abrasive article or attached to another backing material. According to various embodiments, the fibrous backing itself or least a portion of the fibrous backing can be used as an abrasive article independent of the shaped abrasive particles.

According to various embodiments, the methods described herein are simpler than other methods of forming abrasive articles having shaped abrasive particles arranged in predetermined pattern; those methods can include first forming and firing the shaped abrasive particles followed by manually arranging the shaped abrasive particles on a backing in a predetermined pattern using a screen, a secondary tool having a plurality of cavities, or a technique such as electrostatic deposition. According to various embodiments, previous manufacturing methods did not include a backing that is capable of surviving the high temperatures to which the shaped abrasive particles are exposed during firing, therefore the shaped abrasive particles had to be fired and then applied to a backing. According to various embodiments, however, using a fibrous web that is capable of surviving the high temperatures of firing allows shaped abrasive particles to be arranged in a predetermined pattern prior to and through firing, thus obviating the need for an additional step of arranging the shaped abrasive particles in a predetermined pattern following firing.

### BRIEF DESCRIPTION OF THE FIGURES

The drawings illustrate generally, by way of example, but not by way of limitation, various embodiments discussed in the present document.

FIG. 1A is a perspective view of an abrasive article, in accordance with various embodiments.

FIG. 1B is a perspective view of the abrasive article of FIG. 1A where individual shaped abrasive particles have a z-direction rotational angle of about 90 degrees relative to those of FIG. 1A, in accordance with various embodiments.

FIG. 2A is a perspective view of an abrasive article including a flexible backing, in accordance with various embodiments.

FIG. 2B is a perspective view of the abrasive article of FIG. 2B where individual shaped abrasive particles have a z-direction rotational angle of about 90 degrees relative to those of FIG. 2B, in accordance with various embodiments.

FIG. 3 is a perspective view of an abrasive article where individual shaped abrasive particles are laid flat on individual fibers, in accordance with various embodiments.

FIGS. 4A-4D are schematic diagrams of shaped abrasive particles having a planar trigonal shape, in accordance with various embodiments.

FIGS. 5A-5E are schematic diagrams of shaped abrasive particles having a tetrahedral shape, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

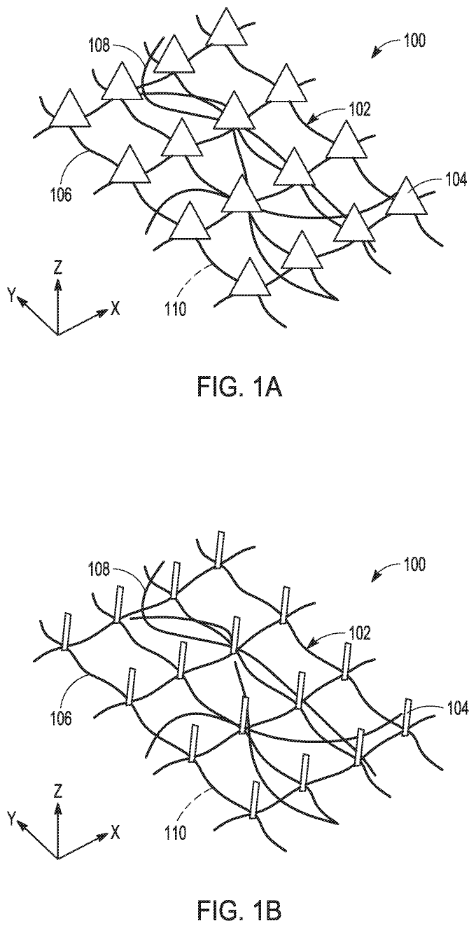

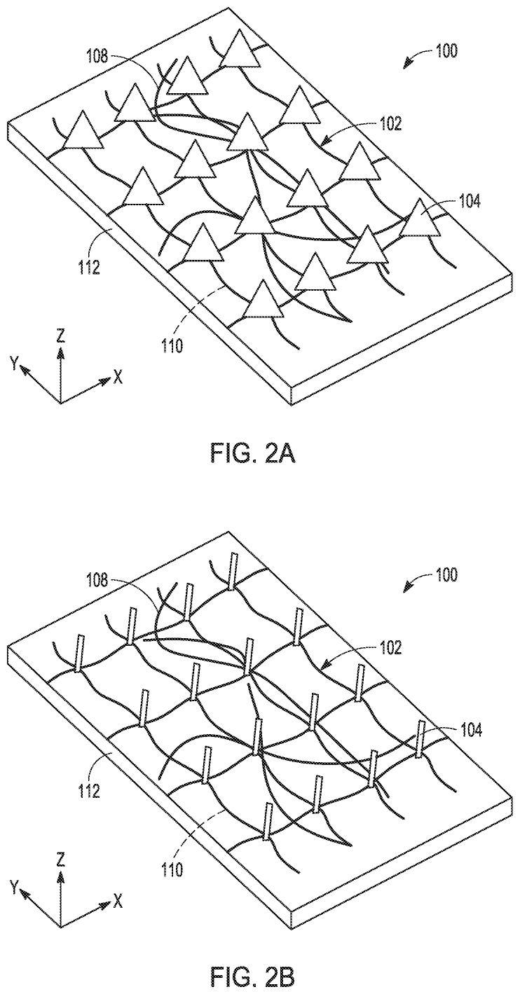

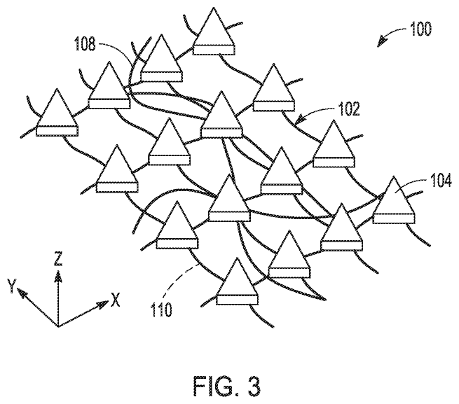

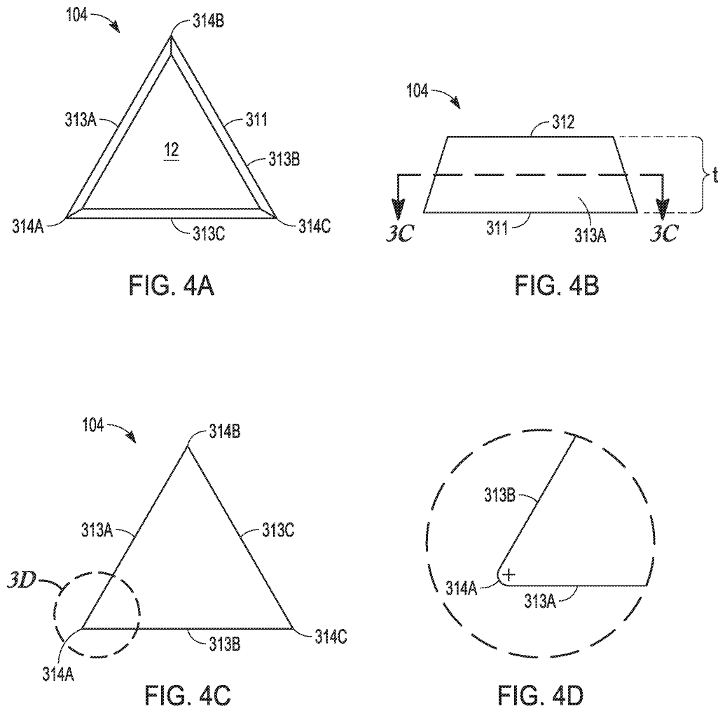

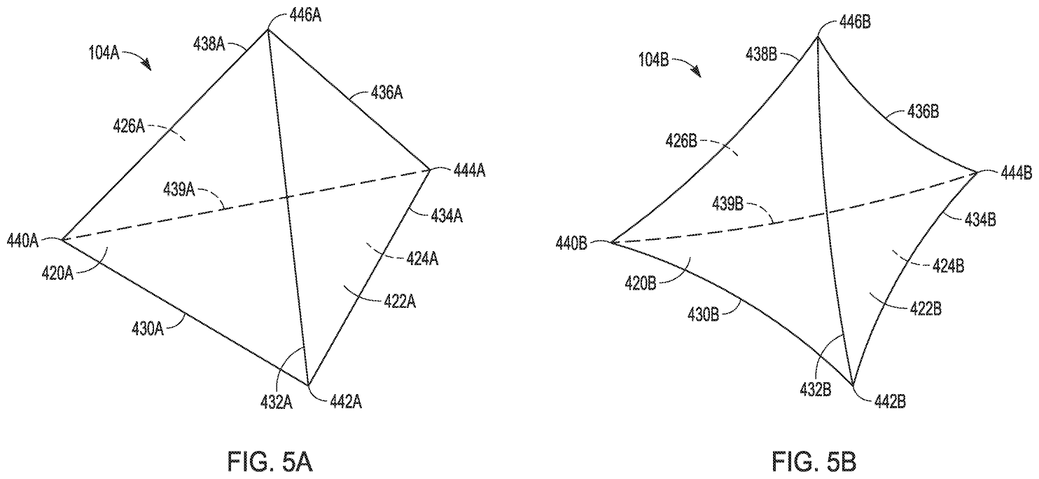

FIGS. 1A, 1B, 2A, 2B, 3, 4A-4D, and 5A-5D show similar components and are discussed concurrently. According to various embodiments of the present disclosure, abrasive article 100, or a preform thereof, includes fibrous web 102 and shaped abrasive particles 104 extending away from fibrous web 102 long at least one of a length or width of individual shaped abrasive particles 104. Fibrous web 102 can be flexible and includes a plurality of high-heat resistant fibers 106, or precursors thereof, to which shaped abrasive particles 104 are integrally attached. As shown, shaped abrasive particles 104 are spatially arranged according to a predetermined pattern. FIGS. 1A-2B show shaped abrasive particles arranged in a plurality of rows. In further embodiments, shaped abrasive particles 104 can form any other suitable pattern such as a plurality of circles.

High-heat resistant fibers 106 have good heat resistance over a wide range of temperatures. For example, high-heat resistant fibers 106 can independently be heat resistant to a temperature of at least about 500° C., at least about 1000° C., at least about 1500° C., at least about 2000° C., at least about 2500° C., in a range of from about 500° C. to about 2500° C., about 1000° C. to about 2000° C., or less than, equal to, or greater than about 500° C., 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, or about 2500° C. As understood herein “heat resistance” or “heat resistant” can be understood to refer to many properties of high-heat resistant fibers 106. For example, high-heat resistant fibers 106 can be able to retain sufficient mechanical strength upon exposure to heat such that abrasive article 100 does not crumble upon exposure to heat. In other measurements, high-heat resistant fibers 106 can retain about 50% to about 100% of its initial strength, about 60% to about 80%, or less than, equal to, or greater than about 50%, 55, 60, 65, 70, 75, 80, 85, 90, 95, or about 100%. Strength retention can be measured by the tear strength in lb/inch in the machine or cross direction. Another measure of the heat resistance of high-heat resistant fibers 106 can be whether abrasive article 100 substantially retains its shape upon exposure to heat. Another measure of the heat resistance can be the ability to bend high-heat resistant fibers 106 over a radius of curvature without breaking.

The heat resistance of high-heat resistant fibers 106 can also be characterized by a degradation or decomposition temperature of the individual high-heat resistant fibers 106. The degradation or decomposition temperature can be understood as the point at which chemical decomposition or thermolysis of high-heat resistant fibers 106 occurs. Chemical decomposition or thermolysis can include oxidation of a non-oxide fiber, evaporation of a component of fiber 106, or a reaction with another component of abrasive article 100 such as a shaped abrasive particle. The degradation or decomposition temperature of high-heat resistant fibers 106 can independently be at a temperature of at least about 500° C., at least about 1000° C., at least about 1500° C., at least about 2000° C., at least about 2500° C., in a range of from about 500° C. to about 2500° C., about 1000° C. to about 2000° C., or less than, equal to, or greater than about 500° C., 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, or about 2500° C.

The heat resistance properties of high-heat resistant fibers 106 can result from the materials of high-heat resistant fibers 106. For example, high-heat resistant fibers 106 can include an inorganic material that independently includes a material chosen from a ceramic material or a metal. Examples of suitable ceramic materials include an aluminosilicate, an alumina, a silica, a silicon carbide, a silicon nitride, a carbon, a glass, a metal, an alumina-phosphorous pentoxide, an alumina-boria-silica, a zirconia, a zirconia-alumina, a zirconia-silica, a sol gel, Al₂O₃, or mixtures thereof. In embodiments where high-heat resistant fibers include Al₂O₃, individual fiber can include 50 wt % to about 100 wt % Al₂O₃, about 80 wt % to about 90 wt %, less than, equal to, or greater than about 50 wt %, 55, 60, 65, 70, 75, 80, 85, 90, 95, or about 100 wt %.

In examples of high-heat resistant fibers 106, which include aluminosilicate, the aluminosilicate can be characterized by the amount of mullite, amount of alumina, or the alumina to silica ratio of the aluminosilicate. In some embodiments the aluminosilicate can be free of mullite. However, in embodiments that do include mullite the aluminosilicate can have a mullite percent of at least 75 wt %, at least 85 wt %, at least 95 wt %, in a range of from about 75 wt % to about 95 wt %, about 75 wt % to about 85 wt %, or less than, equal to, or greater than about 75 wt %, 76, 77, 78, 79, 80, 81, 82, 83, 84, 85, 86, 87, 88, 89, 90, 91, 92, 93, 94, 95, 96, 97, 98, 99, or about 99.9 wt %. Alumina can be in range of from about 30 wt % to about 99.99 wt % of the aluminosilicate, about 30 wt % to about 80 wt %, or less than, equal to, or greater than about 30 wt %, 35, 40, 45, 50, 55, 60, 65, 70, 75, 80, 85, 90, 95, 99, or about 99.9 wt %.

In embodiments where high-heat resistant fibers 106 include metal, the metal can be any suitable metal and can be a thermally resistant metal. The metal can be an elemental metal or an alloy. Examples of suitable metals include iron, gold, silver, platinum, zirconium, tungsten, molybdenum, titanium, tantalum, niobium, alloys thereof, or mixtures thereof.

Fibrous web 102 can include blends of ceramic high-heat resistant fibers 106 and metal high-heat resistant fibers 106. For example, ceramic high-heat resistant fibers 106 can be in a range of from about 5 wt % to about 95 wt % of fibrous web 102, about 50 wt % to about 70 wt %, or less than, equal to, or greater than about 5 wt %, 10, 15, 20, 25, 30, 35, 40, 45, 50, 55, 60, 65, 70, 75, 80, 85, 90, or about 95 wt %. Similarly, metal high-heat resistant fibers 106 can be in a range of from about 5 wt % to about 95 wt % of fibrous web 102, about 50 wt % to about 70 wt %, or less than, equal to, or greater than about 5 wt %, 10, 15, 20, 25, 30, 35, 40, 45, 50, 55, 60, 65, 70, 75, 80, 85, 90, or about 95 wt %.

In some embodiments, high-heat resistant fibers 106 can include both a ceramic and a metal. In these fibers the ceramic and the metal can independently be in a range of from about 1 wt % to about 99.99 wt % of the individual high-heat resistant fiber, about 30 wt % to about 70 wt %, less than, equal to, or greater than about 1 wt %, 5, 10, 15, 20, 25, 30, 35, 40, 45, 50, 55, 60, 65, 70, 75, 80, 85, 90, 95, 99, or about 99.99 wt %.

Individual high-heat resistant fibers 106 can be adhered to one another through a binder that is dispersed throughout fibrous web 102. The binder can be any suitable binder such as an inorganic binder an organic binder or mixtures thereof. The individual high-heat resistant fibers 106 can be adhered to one another at individual contact points to be free of creating agglomerations of fibers. Conversely, individual high-heat resistant fibers 106 can be entangled, braided, woven, or a combination thereof, to form a mat. Fibrous web 102, can conform to any suitable type of web such as a non-woven web, a spun-bound non-woven web, a needle entangled non-woven web, a braided web, a knit web, a woven web, a blown microfiber web, or a combination thereof.

A density of fibrous web 102 can be in a range of from about 0.05 g/cm³ to about 0.8 g/cm³, about 0.10 g/cm³ to about 0.5 g/cm³, or less than, equal to, or greater than about 0.05 g/cm³, 0.10, 0.15, 0.20, 0.25, 0.30, 0.35, 0.40, 0.45, 0.50, 0.55, 0.60, 0.65, 0.70, 0.75, or about 0.80 g/cm³. A basis weight of fibrous web 102 can be in a range of from about 10 g/m² to about 200 g/m², about 50 g/m² to about 100 g/m², or less than, equal to, or greater than about 10 g/m², 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200 g/m².

Individual high-heat resistant fibers 106 of fibrous web 102 can be bonded to each other to form agglomerations. In some embodiments, fibrous web 102 can include one or more yarns that independently include a plurality of high-heat resistant fibers 106. Individual high-heat resistant fibers 106 or yarns thereof can have any suitable length. For example, high-heat resistant fibers 106 can be continuous, or have a length in a range of from about 0.1 mm to about 500 mm, about 0.5 mm to about 25 mm, or less than, equal to, or greater than about 0.1 mm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 380, 385, 390, 395, 400, 405, 410, 415, 420, 425, 430, 435, 440, 445, 450, 455, 460, 465, 470, 475, 480, 485, 490, 495, or about 500 mm.

As shown in FIGS. 1A-2B, abrasive article 100 includes shaped abrasive particles 104. Shaped abrasive particles 104 can be located throughout fibrous web 102, but at least a portion of the total number of shaped abrasive particles 104 are located on first major surface 108. The portion of the plurality of shaped abrasive particles 104 located on first major surface 108 can be in a range of from about 50 wt % to about 100 wt % of the shaped abrasive particles about 70 wt % to about 100 wt %, or less than, equal to, or greater than about 50 wt %, 55, 60, 65, 70, 75, 80, 85, 90, 95 or 100 wt %. Additional shaped abrasive particles 104 can be dispersed through a thickness of abrasive article 100. The thickness of abrasive article 100 is defined from first major surface 108 and second major surface 110. In embodiments in which any one or both of first major surface 108 and second major surface 110 have a non-planar or irregular surface, the thickness is measured from the maximum distance between first major surface 108 and second major surface 110. Shaped abrasive particles 104 that are not located at first major surface 108 can be located anywhere from a range of about 5% to about 100% of a thickness of fibrous web 102, about 20% to about 80%, or less than, equal to, or greater than about 5%, 10, 15, 20, 25, 30, 35, 40, 45, 50, 55, 60, 65, 70, 75, 80, 85, 90, 95 or about 100%. The portion of shaped abrasive particles 104 that are not located at first major surface 108 can be in a range of from about 10 wt % to about 100 wt % of the shaped abrasive particles, about 50 wt % to about 100 wt %, or less than, equal to, or greater than about 10 wt %, 15, 20, 25, 30, 35, 40, 45, 50, 55, 60, 65, 70, 75, 80, 85, 90, 95, or about 100 wt %.

As shown in FIGS. 1A-2B, shaped abrasive particles 104 are oriented tip up. In further embodiments, it is possible for shaped abrasive particles 104 to be laid flat on fibers 106.

Shaped abrasive particles 104 include any particle or particle with at least a portion of the abrasive particle having a predetermined shape. The predetermined shape can be replicated, for example, from a mold cavity that is used to form shaped precursor abrasive particle. In embodiments where shaped abrasive particles 104 are formed in mold cavity, the predetermined geometric shape may substantially replicate the mold cavity used to form shaped abrasive particle 104. Shaped abrasive particles 104 may also replicate a shape of a die in examples where a shaped abrasive particle is formed through extrusion. Shaped abrasive particles 104 may also replicate a shape found in a program, for example, a computer-aided-design (CAD) program, if shaped abrasive particles 104 or abrasive article 100 is formed through an additive manufacturing process. Shaped abrasive particles 104 do not refer to randomly sized crushed abrasive particles formed, for example, by a mechanical crushing operation.

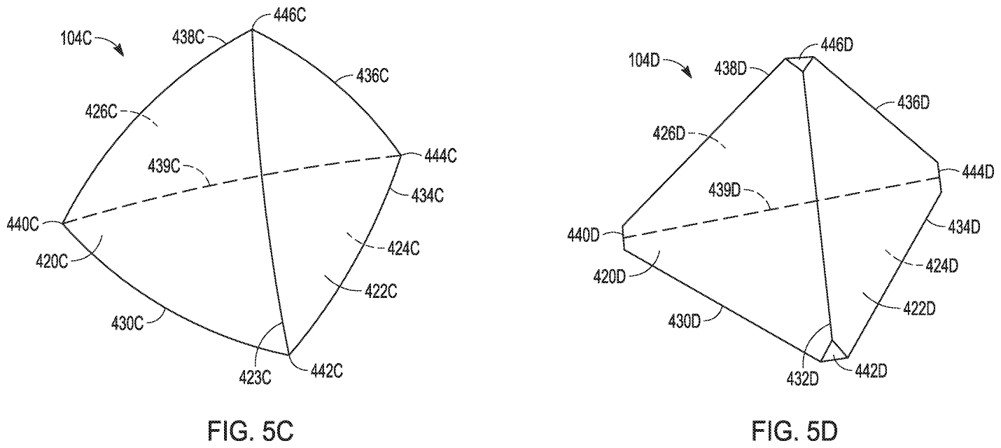

As an example of shaped abrasive particles 104 having a planar trigonal shape, FIGS. 4A-4B show trigonal shaped abrasive particle 104 is bounded by trigonal base 311, trigonal top 312, and a plurality of sidewalls 313A, 313B, 313C connecting base 311 and top 312. Base 311 has tips 314A, 314B, 314C having an average radius of curvature of less than 50 micrometers. FIGS. 4C-4D show one face of shaped abrasive particles 104 to better show radius of curvature for tip 314A. In general, the smaller the radius of curvature, the sharper the sidewall edge will be. In some cases, the base and the top of the shaped abrasive particles are substantially parallel, resulting in prismatic or truncated pyramidal (as shown in FIGS. 4A-4B) shapes, although this is not a requirement. As shown, sidewalls 313A, 313B, 313C have equal dimensions and form dihedral angles with base 311 of about 82 degrees. However, it will be recognized that other dihedral angles (including 90 degrees) can also be used. For example, the dihedral angle between the base and each of the sidewalls can independently range from 45 to 90 degrees, 70 to 90 degrees, or 75 to 85 degrees. The dihedral angle of any sidewall can impart a predetermined tilt angle to individual shaped abrasive particles between any one of base 311 or top 312 and major surface 108 of fibrous web 102.

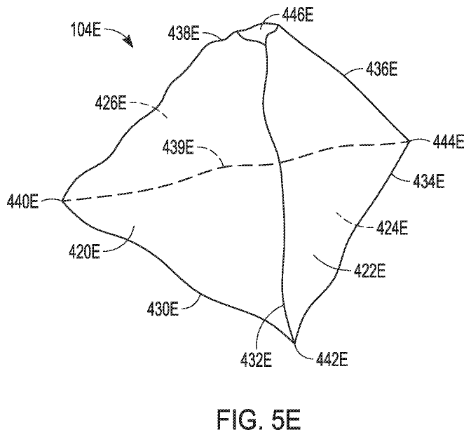

FIGS. 5A-5E show examples of shaped abrasive particles 104 having a tetrahedral shape. As shown in FIGS. 5A-5E, tetrahedral shaped abrasive particles 104 are shaped as regular tetrahedrons. As shown in FIG. 5A, tetrahedral shaped abrasive particle 104A has four faces (420A, 422A, 424A, and 426A) joined by six edges (430A, 432A, 434A, 436A, 438A, and 439A) terminating at four tips (440A, 442A, 444A, and 446A). Each of the faces contacts the other three faces at the edges. While a regular tetrahedron (e.g., having six equal edges and four faces) is depicted in FIG. 5A, it will be recognized that other shapes are also permissible. For example, tetrahedral shaped abrasive particles 104A can be shaped as irregular (e.g., having edges of differing lengths) tetrahedrons.

Referring now to FIG. 5B, tetrahedral shaped abrasive particle 104B has four faces (420B, 422B, 424B, and 426B) joined by six edges (430B, 432B, 434B, 436B, 438B, and 439B) terminating at four tips (440B, 442B, 444B, and 446B). Each of the faces is concave and contacts the other three faces at respective common edges. While a particle with tetrahedral symmetry (e.g., four rotational axes of threefold symmetry and six reflective planes of symmetry) is depicted in FIG. 5B, it will be recognized that other shapes are also permissible. For example, tetrahedral shaped abrasive particles 104B can have one, two, or three concave faces with the remainder being planar.

Referring now to FIG. 5C, tetrahedral shaped abrasive particle 104C has four faces (420C, 422C, 424C, and 426C) joined by six edges (430C, 432C, 434C, 436C, 438C, and 439C) terminating at four tips (440C, 442C, 444C, and 446C). Each of the faces is convex and contacts the other three faces at respective common edges. While a particle with tetrahedral symmetry is depicted in FIG. 5C, it will be recognized that other shapes are also permissible. For example, tetrahedral shaped abrasive particles 104C can have one, two, or three convex faces with the remainder being planar or concave.

Referring now to FIG. 5D, tetrahedral shaped abrasive particle 104D has four faces (420D, 422D, 424D, and 426D) joined by six edges (430D, 432D, 434D, 436D, 438D, and 439D) terminating at four tips (440D, 442D, 444D, and 446D). While a particle with tetrahedral symmetry is depicted in FIG. 5D, it will be recognized that other shapes are also permissible. For example, tetrahedral shaped abrasive particles 104D can have one, two, or three convex faces with the remainder being planar.

Deviations from the depictions in FIGS. 5A-5D can be present. An example of such a tetrahedral shaped abrasive particle 104E is depicted in FIG. 5E, showing tetrahedral shaped abrasive particle 104E that has four faces (40E, 422E, 424E, and 426E) joined by six edges (430E, 432E, 434E, 436E, 438E, and 439E) terminating at four tips (440E, 442E, 444E, and 446E). Each of the faces contacts the other three faces at respective common edges. Each of the faces, edges, and tips has an irregular shape. In further embodiments, shaped abrasive particles 104 can be shaped as platelets, cones, prisms, cylinders, or any suitable shape.

Shaped abrasive particles 104 can include many suitable materials. For example, shaped abrasive particles 104 can include a ceramic material. For example, shaped abrasive particles 104 can independently include alpha alumina, sol-gel derived alpha alumina, or a mixture thereof Examples of specific materials include an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

In some embodiments, at least some of high-heat resistant fibers 106 and shaped abrasive particles 104 can include the same material or mixture of materials. The amount of high-heat resistant fibers 106 and shaped abrasive particles 104 that include the same material or mixture of materials can be in a range of from about 10% wt to about 100 wt % of high-heat resistant fibers 106 and shaped abrasive particles 104, or from about 50 wt % to about 90 wt %, or less than, equal to, or greater than about 10 wt %, 15, 20, 25, 30, 35, 40, 45, 50, 55, 60, 65, 70, 75, 80, 85, 90, 95, or about 100 wt %. In embodiments where high-heat resistant fibers 106 and shaped abrasive particles 104 include the same material or mixture of materials, high-heat resistant fibers 106 can be exposed to at least the same temperatures as shaped abrasive particles 104 are during firing. It is also possible in some embodiments, for high-heat resistant fibers 106 and shaped abrasive particles 104 to include different materials.

In further embodiments a shrinkage (e.g., a linear shrinkage) of the materials of shaped abrasive particles 104 can be substantially equal to the shrinkage (e.g., a linear shrinkage) of the materials of high-heat resistant fibers 106. For example, shaped abrasive particles 104 and high-heat resistant fibers 106 can independently have a shrinkage value in a range of from about 0.01% to about 50%, about 10% to about 45%, about 40% to about 45%, less than, equal to, or greater than about 0.01%, 0.1, 0.5, 1, 3, 5, 10, 15, 20, 25, 30, 35, 40, 45, or about 50%. The individual shrinkage values between high-heat resistant fibers 106 and shaped abrasive particles 104 can be identical or can be within 0.01% to 10% of each other, about 1% to about 5%, less than, equal to, or greater than about 0.01%, 0.05, 0.1, 0.5, 1, 1.5, 2, 2.5, 3, 3.5, 4, 4.5, 5, 6, 6.5, 7, 7.5, 8, 8.5, 9, 9.5, or about 10%. The temperature at which shrinkage can occur can be at a temperature of at least about 500° C., at least about 1000° C., at least about 1500° C., at least about 2000° C., at least about 2500° C., in a range of from about 500° C. to about 2500° C., about 1000° C. to about 2000° C., or less than, equal to, or greater than about 500° C., 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, or about 2500° C. In some embodiments, the shrinkage values can be a measurement of heat resistance. However, in other embodiments, the ability to substantially match the shrinkage value of shaped abrasive particles 104 and high-heat resistant fibers 106 can help to minimize the chance of particle detachment caused by shrinkage mismatch at a bonding site between a high-heat resistant fiber 106 and a shaped abrasive particle 104.

As shown in FIGS. 1A-2B, shaped abrasive particles 104 can form a predetermined and non-random pattern on fibrous web 102. The amount of shaped abrasive particles 104 that conform to a predetermined pattern can be in a range of from about 25 wt % to about 100 wt % of the plurality of shaped abrasive particles 104, about 50 wt % to about 80 wt %, less than, equal to, or greater than about 25 wt %, 30, 35, 40, 45, 50, 55, 60, 65, 70, 75, 80, 85, 90, 95, or about 100 wt %.

The predetermined pattern can take on any suitable pattern. For example, as shown, the predetermined pattern of shaped abrasive particles 104 forms a plurality of substantially parallel lines. In further embodiments, the predetermined pattern can include a plurality of circles. Additionally, in further embodiments adjacent shaped abrasive particles 104 can be staggered with respect to each other. Additional predetermined patterns of shaped abrasive particles 104 are also within the scope of this disclosure. For example, shaped abrasive particles 104 can be arranged in a pattern that forms a word or image. Shaped abrasive particles 104 can also be arranged in a pattern that forms an image if abrasive article 100 is rotated at a predetermined speed.

Additionally, according to various embodiments, a z-direction rotational angle about a line perpendicular to major surface 108 of fibrous web 102 and passing through individual shaped abrasive particles 104 of the plurality of shaped abrasive particles is substantially the same for a portion of the plurality of shaped abrasive particles 104. As shown in FIGS. 1A, and 2A each shaped abrasive particle has substantially the same z-direction rotational angle. As shown in FIGS. 1B and 2B, each shaped abrasive particle has substantially the same z-direction rotational angle but are rotated about 90 degrees relative to the angle shown in FIGS. 1A and 2A. In further embodiments the portion of shaped abrasive particles 104 having substantially the same z-direction rotational angle are in a range of from about 25 wt % to about 100 wt % of the plurality of shaped abrasive particles 104, about 50 wt % to about 80 wt %, less than equal to, or greater than about 25 wt %, 30, 35, 40, 45, 50, 55, 60, 65, 70, 75, 80, 85, 90, 95, or about 100 wt %.

Additionally, according to various embodiments, shaped abrasive particles 104 can be arranged on fibrous web 102 to achieve a predetermined rake angle. A rake angle can be characterized by an angle measured between major surface 108 of fibrous web 102 and a leading surface of an individual shaped abrasive particle 104. Individual rake angle values can be chosen from a value in a range of from about 10 degrees to about 170 degrees, about 80 degrees to about 100 degrees, about 85 degrees to about 95 degrees, or less than, equal to, or greater than about 10 degrees, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 170 degrees. The value of the rake angle can be selected for the intended purpose of abrasive article 100. For example, if the rake angle is equal to or less than 90 degrees, abrasive article 100 may be well suited to remove material from a workpiece, achieve a deep cut in the workpiece, or remove a large piece of swarf from the workpiece. Conversely, if the rake angle is greater than 90 degrees, abrasive article 100 may still have some of the characteristics previously described, but may additionally be better suited for finishing a surface of the workpiece.

In addition to shaped abrasive particles 104, abrasive article 100 can include crushed abrasive particles. Crushed abrasive particles, in general, do not have a replicated shape or a consistent size. Crushed abrasive particles and shaped abrasive particles 104 can include the same material or mixture of materials or can include different materials.

In embodiments that include a blend of shaped abrasive particles 104 and crushed abrasive particles, shaped abrasive particles can be in a range of from about 5 wt % to about 95 wt % of the blend, about 30 wt % to about 80 wt %, less than, equal to, or greater than about 5 wt %, 10, 15, 20, 25, 30, 35, 40, 45, 50, 55, 60, 65, 70, 75, 80, 85, 90, or about 95 wt %.

Shaped abrasive particles 104 and crushed abrasive particles can be independently sized according to an abrasives industry recognized specified nominal grade. Abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

Abrasive article 100 can be one of many suitable abrasive articles. For example, abrasive article 100 can be a non-woven abrasive article, a coated abrasive article, or a bonded abrasive article. As shown in FIGS. 1A-2B, abrasive article 100 is a sheet. However, in further embodiments, abrasive article 100 can take the form of a wheel or a continuous belt. Examples of suitable wheels include a depressed center grinding wheel. In other examples, the abrasive article can be a cut-off wheel, cutting wheel, a cut-and-grind wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, or a double disk grinding wheel. The dimensions of the wheel can be any suitable size; for example the diameter can range from 2 cm to about 2000 cm, about 100 cm to about 500 cm, less than, equal to, or greater than about 2 cm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 cm.

As shown in FIGS. 2A and 2B, fibrous web 102 can be attached to flexible backing 112. Flexible backing 112 can help to provide structural support to abrasive article 100 while allowing abrasive article 100 to be sufficiently flexible during use across various substrates. Suitable examples of materials for flexible backing 112 include a polymeric film, a metal foil, a woven fabric, a knitted fabric, paper, a vulcanized fiber, a nonwoven, a foam, a screen, a laminate, or a combination thereof.

Fibrous web 102 and flexible backing 112 can be adhered to one another through a make coat. Shaped abrasive particles 104 can be adhered to fibrous web 102 and to the make coat through a size coat. The make coat and the size coat can include any suitable resin capable of creating adhesion. For example, at least one of the make coat and the size coat comprise a phenolic resin, an epoxy resin, a urea-formaldehyde resin, an acrylate resin, an aminoplast resin, a melamine resin, an acrylated epoxy resin, a urethane resin, or a mixture thereof. The material or mixture of materials of each of the make coat and the size coat can be the same or different. In some embodiments, the make coat, the size coat or both can include any additional component such as a filler, a grinding aid, a wetting agent, a surfactant, a dye, a pigment, a coupling agent, an adhesion promoter, or a mixture thereof. Suitable examples of fillers include calcium carbonate, silica, talc, clay, calcium metasilicate, dolomite, aluminum sulfate, or a mixture thereof. In further embodiments, a supersize coat can be disposed over the size coat. The size coat and the supersize coat can include the same material or different materials.

In various embodiments, abrasive article 100 can be a bonded abrasive article. In embodiments in which abrasive article 100 is a bonded abrasive articles, fibrous web 102 as well as shaped abrasive particles 104 are at least partially encapsulated by a binder material. The binder material can include an organic binder material, a vitrified binder material, or a metallic binder material.

Organic binders, as described herein, can be included in abrasive article 100 in amounts ranging from about 5 wt % to about 50 wt % of the total weight of the bonded abrasive article, or from about 10 wt % to about 25 wt %, or from about 15 wt % to about 24 wt %, or less than about, equal to about, or greater than about, 10 wt %, 15, 20, 25, 30, 35, 40, or 45 wt %.

Suitable organic binders are those that can be cured (e.g., polymerized and/or crosslinked) to form useful organic binders. These binders include, for example, one or more phenolic resins (including novolac and/or resole phenolic resins), one or more epoxy resins, one or more urea-formaldehyde binders, one or more polyester resins, one or more polyimide resins, one or more rubbers, one or more polybenzimidazole resins, one or more shellacs, one or more acrylic monomers and/or oligomers, and combinations thereof. The organic binder precursor(s) may be combined with additional components such as, for example, curatives, hardeners, catalysts, initiators, colorants, antistatic agents, grinding aids, and lubricants.

Useful phenolic resins include novolac and resole phenolic resins. Novolac phenolic resins are characterized by being acid-catalyzed and as having a ratio of formaldehyde to phenol of less than one, for example, between 0.5:1 and 0.8:1. Resole phenolic resins are characterized by being alkaline catalyzed and having a ratio of formaldehyde to phenol of greater than or equal to one, for example from 1:1 to 3:1. Novolac and resole phenolic resins may be chemically modified (e.g., by reaction with epoxy compounds), or they may be unmodified. Exemplary acidic catalysts suitable for curing phenolic resins include sulfuric, hydrochloric, phosphoric, oxalic, and p-toluenesulfonic acids. Alkaline catalysts suitable for curing phenolic resins include sodium hydroxide, barium hydroxide, potassium hydroxide, calcium hydroxide, organic amines, or sodium carbonate.

Suitable phenolic resins are available from commercial sources. Examples of commercially available novolac resins include DUREZ 1364, a two-step, powdered phenolic resin (marketed by Durez Corporation, Addison, Tex., under the trade designation VARCUM (e.g., 29302), or DURITE RESIN AD-5534 (marketed by Hexion, Inc., Louisville, Ky.). Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co., Bartow, Fla. under the trade designation AEROFENE (e.g., AEROFENE 295); and those marketed by Kangnam Chemical Company Ltd., Seoul, South Korea under the trade designation “PHENOLITE” (e.g., PHENOLITE TD-2207).

With regards to vitrified binding materials, vitreous bonding materials, which exhibit an amorphous structure and are hard, are well known in the art. In some cases, the vitreous bonding material includes crystalline phases. Examples of metal oxides that are used to form vitreous bonding materials include: silica, silicates, alumina, soda, calcia, potassia, titania, iron oxide, zinc oxide, lithium oxide, magnesia, boria, aluminum silicate, borosilicate glass, lithium aluminum silicate, combinations thereof, and the like. Vitreous bonding materials can be formed from a composition comprising from 10 to 100% glass frit, although more typically the composition comprises 20% to 80% glass frit, or 30% to 70% glass frit. The remaining portion of the vitreous bonding material can be a non-frit material. Alternatively, the vitreous bond may be derived from a non-frit containing composition. Vitreous bonding materials are typically matured at a temperature(s) in the range from about 700° C. to about 1500° C., about 800° C. to about 1300° C., about 900° C. to about 1200° C., or about 950° C. to about 1100° C. The actual temperature at which the bond is matured depends, for example, on the particular bond chemistry. Preferred vitrified bonding materials may include those comprising silica, alumina (preferably, at least 10 percent by weight alumina), and boria (preferably, at least 10 percent by weight boria). In most cases the vitrified bonding materials further comprise alkali metal oxide(s) (e.g., Na₂O and K₂O) (in some cases at least 10 percent by weight alkali metal oxide(s)).

As shown in FIGS. 1A-2B, fibrous web 102 and shaped abrasive particles 104 are distinct structures. That is, as shown, fibrous web 102 and shaped abrasive particles do not form a monolithic structure. However, in some embodiments, it is possible for fibrous web 102 and shaped abrasive particles 104 can form a monolithic structure. This can be the result, for example, of at least some of the materials of fibrous web 102 and shaped abrasive particles 104 diffusing into one another. In some embodiments, shaped abrasive particles 104 can be bonded to high-heat resistant fiber 106. For example, shaped abrasive particles 104 can be sintered to high-heat resistant fiber 106 during firing. Additionally, an inorganic binder can be applied to fibrous web 102 and shaped abrasive particles 104 prior to firing.

Abrasive article 100 can be manufactured according many suitable methods or techniques. An example of a suitable method can include contacting at least a portion of a plurality of cavities or recesses of a production tool with a flowable and dryable shaped abrasive particle precursor dispersion. The shaped abrasive particle precursor dispersion can include a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle 104 can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation.

The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

The production tool can include a plurality of cavities formed in at least one major surface of the tool. In some examples, the tool is formed as a production tool, which can be, for example, a belt, a sheet, a continuous web, a coating roll such as a rotogravure roll, a sleeve mounted on a coating roll, or a die. In one example, the production tool can include polymeric material.

Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities or recesses can be from an opening in the top surface or bottom surface of the tool. In some examples, the cavities can extend for the entire thickness of the tool. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particle 104. The depth dimension is equal to the perpendicular distance from the top surface to the lowermost point on the bottom surface. The depth of a given cavity can be uniform or can vary along its length and/or width. The cavities of a given mold can be of the same shape or of different shapes.

The cavities can be further arranged with respect to one another in a pattern that conforms to the predetermined pattern of shaped abrasive particles shown in FIGS. 1 and 2. Moreover, each of cavities can be formed to impart the desired z-direction rotational angle to each shaped abrasive particle 104.

To effectively deposit the precursor dispersion into each cavities a knife roll coater or vacuum slot die coater can be used. Additionally, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

After a sufficient amount of precursor composition is deposited in the cavities or recesses of the production tool, fibrous web 102 is brought into contact with at least a portion of shaped abrasive particles 104. Fibrous web 102 and shaped abrasive particles can be forced into contact with an apparatus such as a hand roller. After contact, fibrous web 102 and shaped abrasive particles 104 form an abrasive article precursor.

The shaped abrasive particle precursor can be preheated to a temperature in a range of from about 30° C. to about 700° C., about 30° C. to about 75° C., 100° C. to about 300° C., or less than, equal to, or greater than about 30° C., 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300° C. Preheating can help to dry the precursor or remove undesirable low volatility organic components from the shaped abrasive article precursor. The method can include multiple preheating cycles that can range for any amount of time. Preheating cycles can be used to dry the components.

Following preheating, the shaped abrasive article precursor can be fired or sintered to produce abrasive article 100. Firing can including heating shaped abrasive article precursor to a temperature of at least about 800° C., at least about 1000° C., at least about 1500° C., at least about 2000° C., at least about 2500° C., in a range of from about 800° C. to about 2500° C., about 1000° C. to about 2000° C., less than, equal to, or greater than about 800° C., 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, or about 2500° C.

After firing abrasive article 100 is substantially intact. Abrasive article can be handled without falling apart and has substantially structural integrity to be used to abrade a workpiece. Notably, performing this method allows for the formation of an abrasive article having a predetermined pattern of shaped abrasive particles 104 in fewer steps than methods in which abrasive particles 104 are formed in a separate step before an abrasive article is formed. For example, to create an abrasive article having a predetermined pattern using other methods it may be necessary to first form shaped abrasive particles and then manually deposit the shaped abrasive particles to a backing or to otherwise arrange them. In contrast, the instant method provides fibrous web 102, which is capable of surviving firing. Thus fibrous web 102 can be fired along with shaped abrasive particle precursors such that when shaped abrasive particles 104 are actually formed they are attached to fibrous web 102 and form a predetermined pattern.

In some embodiments, fibrous web 102 is attached to flexible backing 112. Fibrous web 102 and flexible backing 112 can be attached with any of the make coat materials described herein. In some further embodiments abrasive article 100 can be broken in to smaller segments.

According to various embodiments, a method of using abrasive article 100 can include contacting abrasive articles 100 with a workpiece. The workpiece can include many different materials such as steel, carbon steel, aluminum, aluminum alloys, wood or mixtures thereof. At least one of abrasive article 100 and the workpiece are moved relative to each other and at least a portion of the workpiece is removed.

### EXAMPLES

Various embodiments of the present disclosure can be better understood by reference to the following Examples which are offered by way of illustration. The present disclosure is not limited to the Examples given herein.

Unless otherwise noted, all parts, percentages, ratios, etc. in the Examples and the rest of the specification are by weight.

Unless stated otherwise, all other reagents were obtained, or are available from fine chemical vendors such as Sigma-Aldrich Company, St. Louis, Mo., or may be synthesized by known methods.

### Unit Abbreviations Used in the Examples

° C.: degree Celsius
cm: centimeter
g: gram
g/m²: grams per square meter
rpm: revolutions per minute
mm: millimeter
wt. %: weight percent

Materials used in the Examples are described in Table 1:

TABLE 1

| ABBREVIATION | DESCRIPTION |
|---|---|
| Ceramic fibers | Unless otherwise noted, the ceramic fibers and textiles disclosed in the |
| and textiles | examples are commercially available materials under the tradename |
| | 3M ™ Nextel ™ from 3M Company, MN, USA. The ceramic fibers may |
| | be formed of any one of or a combination of single fiber, twisted yarns, |
| | filament yarns, mats, webs, nonwovens, weaving clothes and textiles. |
| | The examples of ceramic fibers and woven ceramic fabrics are 3M ™ |
| | Nextel ™ Woven Ceramic Fabrics 312, 440, 610 and 720 or the |
| | combination of above. |
| MAT-1 | Fibrous mats were prepared according to the disclosure of PCT Pat. App. |
| | WO 2018/093624 (Rovere et al.), the contents of which are hereby |
| | incorporated by reference. The fiber mats were formed from entangled |
| | aluminosilicate ceramic filaments. |
| MAT-2 | Fibrous ceramic mats were prepared by assembling 3M ™ Nextel ™ fiber |
| | into a mat format with a binder. The binder can be a durable binder such |
| | as ceramic materials or a temporary binder such as an adhesive tape or a |
| | glue. An example of MAT-2 is made as follows: 3M ™ Nextel ™ 720 |
| | ceramic fiber was winded onto a glass rod (2.5 inch diameter) to get a |
| | roller wrapped with Nextel 720 fiber. Rolling the glass rod randomly on |
| | the adhesive side of a 3M post-it poster paper, the fiber will stick to the |
| | adhesive side and form a nonwoven mat. The poster paper will be |
| | eliminated during pre-fire process. |
| Micro-replication | A production tool described in WO application 2015/100018 and U.S. Pat. No. |
| tool for coated | 9,776,302 as a carrier allows for making abrasive article with precision |
| abrasives | mineral placement. In general, the carrier member has cavities |
| | formed therein that extend into, and optionally through, the carrier |
| | member from the dispensing surface toward the back surface. |
| | Abrasive particles are removably and completely disposed within at least |
| | some of the cavities. Specific embodiments of production |
| | tools suitable for use in the abrasive particle positioning system are |
| | detailed in WO application 2015/100018. |
| Micro-replication | A production tool described in WO application 2017/083255 as a carrier |
| tool for cut-off | having first and second opposed horizontal major surfaces, the first major |
| wheels | surface defining precisely-shaped cavities, wherein each horizontally- |
| | oriented precisely-shaped cavity has a predetermined location with |
| | respect to the surface of the tool, wherein each precisely-shaped cavity |
| | has a horizontal bottom surface. |
| Sol-Gel Precursor | In general, Sol-Gel Precursor pre-Mix is a dispersion comprising water, |
| pre-Mix | colloid alumina source, and optionally peptizing agent (e.g., an acid such |
| | as nitric acid) as described in US patent U.S. Pat. No. 6,287,353. An example of |
| | precursor sol-gel mixture was made using the following recipe: |
| | aluminum oxide monohydrate powder (1600 parts) having the trade |
| | designation “DISPERAL’ (Sasol Chemicals North America LLC, |
| | Houston, Texas) was dispersed by high shear mixing a solution |
| | containing water (2400 parts) and 70% aqueous nitric acid (72 parts) for |
| | 11 minutes. The resulting Sol-gel precursor was aged for at least 1 hour |
| | before use. |
| Slurry Precursor | In general, Slurry Precursor Pre-Mix is a dispersion comprising water, |
| Pre-Mix | non-colloidal alumina powder source, and optionally stabilizing agent |
| | and temporary binder, as described in U.S. Pat. Appl. No. 2015/0267097 |
| | A1. |
| SG-SAP | Sol-Gel Shaped abrasive particles (SG-SAP) were prepared according to |
| | the disclosure of U.S. Pat. No. 8,142,531 (Adefris et al). The shaped |
| | abrasive particles were prepared by molding the Sol-Gel Precursor pre- |
| | Mix in equilateral triangle-shaped polypropylene mold cavities. After |
| | drying and firing, the resulting shaped abrasive particles were about 0.18 |
| | mm (side length) × 0.04 mm thick, with a draft angle approximately 98 |
| | degrees. |
| PD-SAP | Powder derived Shaped abrasive particles (PD-SAP) were prepared |
| | according to the disclosure of U.S. Pat. Appl. No. 2015/0267097 A1 |
| | (Rosenflanz et al). The PD-SAP were prepared by molding Slurry |
| | Precursor Pre-Mix in equilateral triangle-shaped polypropylene mold |
| | cavities. After drying and firing, the resulting shaped abrasive particles |
| | were about 0.18 mm (side length) × 0.04 mm thick, with a draft angle |
| | approximately 98 degrees. |
| Fiber disc backing | Precut vulcanized fibre discs blanks with a diameter of 17.8 cm, a center |
| | hole of 2.2 cm and thickness of 0.83 mm were obtained under trade |
| | designation “Dynos Vulcanized Fibre” from DYNOS GMBH, Troisdorf, |
| | Germany. |
| RA | Mold releasing agent. In many embodiments, a mold release agent may |
| | include in the precursor pre-mix or coat onto the mold surface as |
| | disclosed in WO2014/070468A1 (Rosenflanz, et al), to aid in removing |
| | the shaped abrasive precursor particles from the substrate, if desired. |
| | Typical mold release agents include oils such as peanut oil or mineral oil, |
| | fish oil, silicones, polytetrafluoroethylene (ptfe), zinc stearate, and |
| | graphite. In general, a mold release agent such as peanut oil, in a liquid, |
| | such as water or alcohol, is applied to the surfaces of the production |
| | tooling in contact with the slurry such that between about 0.1 mg/in² (0.6 |
| | mg/cm²) to about 3.0 mg/in² (20 mg/cm²), or between about 0.1 mg/in² |
| | (0.6 mg/cm²) to about 5.0 mg/in² (30 mg/cm²) of the mold release agent |
| | is present when a mold release is desired. Unless otherwise noted, the |
| | release agent solution is 0.2% peanut oil in methanol by weight. |
| PF1 | Phenol-formaldehyde resin having a phenol to formaldehyde molar ratio |
| | of 1:1.5-2.1, and catalyzed with 2.5 percent by weight potassium |
| | hydroxide. |
| ER1 | Aqueous Epoxy dispersion commercially available under the trade name |
| | “EPI-REZ ™ 3522-W60” from Hexion Specialty Chemical, Inc., |
| | Louisville, Kentucky |
| CACO | Calcium Carbonate commercially available under trade name “Hubercarb |
| | Q325” from Hubercarb Engineered Materials, Atlanta Georgia. |
| CRY | Cryolite, obtained under the trade designation “CRYOLITE RTN-C” |
| | from Freebee A/S, Ullerslev, Denmark. |
| KBF4 | Potassium tetrafluoroborate, obtained under the trade designation, |
| | “Potassium Fluoroborate Spec 101” from Atotech USA, Inc., Rockhill, |
| | South Carolina. |
| IO | Red iron oxide pigment, obtained under the trade designation “KROMA |
| | RO-3097” from Elementis Specialties, Inc., East Saint Louis, Illinois. |
| ECI | 2-Ethyl-4-methyl imidazole, obtained under the trade designation “EMI- |
| | 2,4” from Air Products, Allentown, Pennsylvania |
| Make resin 1 | The Phenolic make resin 1 was prepared by mixing 49.2 parts by weight |
| | of PR1; 40.6 parts by weight of CACO; and 10.2 parts by weight of |
| | deionized water. |
| Size Resin 1 | The Phenolic Size Resin 1 was prepared by mixing 40.6 parts by weight |
| | of PR1; 69.9 parts by weight of CRY; 2.5 parts by weight IO; and 25 |
| | parts by weight deionized water. |
| SEM | Scanning Electron Microscope, JSM-7610F, JEOL Ltd. (Japan) |
| Keyence | Optical microscope, VK-5000 made by Keyence Corporation (USA) |

### Example-1

A first ceramic abrasive web was formed by coating the micro-replication tool for coated abrasives (7-inch diameter disc) with a mold release agent using a brush. The surface was dried at 50° C. for 5 minutes or blown with pressured air for 1 minute. The cavities of the micro-replication tool for coated abrasives with the Sol-Gel Precursor pre-Mix were filled using a Thrifty Trowel 4″ putty knife. The precursor pre-Mix was evenly spread onto the surface of the tool until all the cavities was filled with the pre-Mix. In total, 22 g Sol-Gel Precursor pre-Mix was applied onto the production tool. Ceramic MAT (3M™ Nextel™ 440) was laminated onto the surface of the micro-replication tool for coated abrasives using a hand rubber roller (Safety-Walk™ Hand Roller from 3M Company, MN, USA).

The micro-replication tool for coated abrasives together with the precursor and ceramic MAT were dried at 50° C. for 5 minutes and then 75° C. for 5 minutes. The ceramic web (together with the dry PSG particle arrays) was peeled off from the micro-replication tooling by hand. Following removal, the ceramic web was pre-fired at 650° C. for 20 minutes to remove any organic residuals, and then cooled down to room temperature (25° C.).

The dried sol gel precursors were doped with a mixed nitrate solution of the following concentrations (reported as oxides): 1.8% each of MgO, Y₂O₃, Nd₂O₃ and La₂O₃. The excess nitrate solution was removed, the sample were dried at 75° C. for 10 min, and then pre-fired at 650° C. for 20 minutes.

Finally, the abrasive article precursor web was then final fired at 1400° C. for 20 minutes to convert to abrasive web. The final abrasive web can be cut into any shape or size for further application.

### Example-2

A second ceramic abrasive web was formed using the same procedure as Example-1, with the exception that a Ceramic MAT-2 (3M™ Nextel™ 720) was used instead of Ceramic MAT (3M™ Nextel™ 440).

### Example-3

A third ceramic abrasive web was formed using the same procedure as Example-1 except the micro-replication tool for coated abrasives had right angle shaped cavity was used.

### Example-4

A fourth ceramic abrasive web was formed using the same procedure as Example-1 except a Slurry Precursor Pre-Mix was used instead of the Sol-Gel Precursor pre-Mix and a production tool for making cut-off wheels was used instead of the micro-replication tool for coated abrasives.

### Methods of Making Abrasive Articles

A precut vulcanized fiber disc blank with a diameter of 7 inches (17.8 cm), having a center hole of ⅞ inch (2.2 cm) diameter and a thickness of 0.83 mm (33 mils) obtained under the trade designation “DYNOS VULCANIZED FIBRE” from DYNOS GmbH, Troisdorf, Germany was used as the abrasive substrate. The fiber substrate was coated by brush with Make Resin 1 to a weight of 4.5+/−0.5 grams.

The ceramic abrasive web was laminated onto backing: the ceramic abrasive web was placed onto the make resin layer and then pressurized with rubber roller. The disc was given a make pre-cure at 90 C for 1 hour followed by 103 C for 3 hours.

The precured discs were then coated by brush with size resin 1. Excess size resin was removed with a dry brush until the flooded glossy appearance was reduced to a matte appearance. The size coated discs were weighed to establish the size resin weight. The amount of size resin added was dependent on the mineral composition and weights, but was typically between 12 and 28 grams per disc. In this example, 11.5-13.0 g size coating was used. The discs were cured for 90 minutes at 90° C., followed by 16 hours at 103° C. The discs were then optionally coated by brush with a supersize resin if needed. In this example, no supersize coating was used. The supersize coated discs received an additional cure at 125° C. C for 3 hours. The cured discs were orthogonally flexed over a 1.5 inch (3.8 cm) diameter roller.

### Additional Embodiments

The following exemplary embodiments are provided, the numbering of which is not to be construed as designating levels of importance:

Embodiment 1 provides an abrasive article, comprising:

a fibrous web comprising a plurality high-heat resistant fibers; and

a plurality of shaped abrasive particles attached to the fibrous web.

Embodiment 2 provides the abrasive article of Embodiment 1, wherein the fibers independently comprises a ceramic, a metal, or a combination thereof.

Embodiment 3 provides the abrasive article of any one of Embodiments 1 or 2, wherein the fibers are independently heat resistant to a temperature of at least about 500° C.

Embodiment 4 provides the abrasive article of any one of Embodiments 1-3, wherein the fibers are independently heat resistant to a temperature of at least about 1000° C.

Embodiment 5 provides the abrasive article of any one of Embodiments 1-4, wherein the fibers are independently heat resistant to a temperature of at least about 1500° C.

Embodiment 6 provides the abrasive article of any one of Embodiments 1-5, wherein the fibers are independently heat resistant to a temperature of at least about 2000° C.

Embodiment 7 provides the abrasive article of any one of Embodiments 1-6, wherein the fibers are independently heat resistant to a temperature of at least about 2500° C.

Embodiment 8 provides the abrasive article of any one of Embodiments 1-7, wherein the fibers are independently heat resistant to a temperature in a range of from about 500° C. to about 2500° C.

Embodiment 9 provides the abrasive article of any one of Embodiments 1-8, wherein the fibers are independently heat resistant to a temperature in a range of from about 1000° C. to about 2000° C.

Embodiment 10 provides the abrasive article of any one of Embodiments 1-9, wherein a degradation temperature of the fibers is independently at least about 500° C.

Embodiment 11 provides the abrasive article of any one of Embodiments 1-10, wherein a degradation temperature of the fibers is independently at least about 1000° C.

Embodiment 12 provides the abrasive article of any one of Embodiments 1-11, wherein a degradation temperature of the fibers is independently at least about 1500° C.

Embodiment 13 provides the abrasive article of any one of Embodiments 1-12, wherein a degradation temperature of the fibers is independently at least about 2000° C.

Embodiment 14 provides the abrasive article of any one of Embodiments 1-13, wherein a degradation temperature of the fibers is independently at least about 2500° C.

Embodiment 15 provides the abrasive article of any one of Embodiments 1-14, wherein a degradation temperature of the fibers is independently in a range of from at least about 500° C. to about 2500° C.

Embodiment 16 provides the abrasive article of any one of Embodiments 1-15, wherein a degradation temperature of the fibers is independently in a range of at least about 1000° C. to about 2000° C.

Embodiment 17 provides the abrasive article of any one of Embodiments 1-16, wherein an amount of linear shrinkage in a longitudinal direction of the fibers post firing is in a range of from about 0.01% to about 50% at a temperature of at least about 500° C.

Embodiment 18 provides the abrasive article of any one of Embodiments 1-17, wherein an amount of linear shrinkage in a longitudinal direction of the fibers post firing is in a range of from about 0.01% to about 50% at a temperature of at least about 1000° C.

Embodiment 19 provides the abrasive article of any one of Embodiments 1-18, wherein an amount of linear shrinkage in a longitudinal direction of the fibers post firing is in a range of from about 0.01% to about 50% at a temperature of at least about 1500° C.

Embodiment 20 provides the abrasive article of any one of Embodiments 1-19, an amount of linear shrinkage in a longitudinal direction of the fibers post firing is in a range of from about 0.01% to about 50% at a temperature of at least about 2000° C.

Embodiment 21 provides the abrasive article of any one of Embodiments 1-20, an amount of linear shrinkage in a longitudinal direction of the fibers post firing is in a range of from about 0.01% to about 50% at a temperature of at least about 2500° C.

Embodiment 22 provides the abrasive article of any one of Embodiments 1-21, an amount of linear shrinkage in a longitudinal direction of the fibers post firing is in a range of from about 0.01% to about 50% at a temperature of from about 500° C. to about 2500° C.

Embodiment 23 provides the abrasive article of any one of Embodiments 1-22, an amount of linear shrinkage in a longitudinal direction of the fibers post firing is in a range of from about 0.01% to about 50% at a temperature of from about 1000° C. to about 2000° C.

Embodiment 24 provides the abrasive article of any one of Embodiments 2-23, wherein the ceramic is chosen from an aluminosilicate, an alumina, a silica, a silicon carbide, a silicon nitride, a carbon, a glass, a metal, an alumina-phosphorous pentoxide, an alumina-boria-silica, a zirconia, a zirconia-alumina, a zirconia-silica, and mixtures thereof.

Embodiment 25 provides the abrasive article of Embodiment 24, wherein the aluminosilicate has a mullite percent of at least 75 wt %.

Embodiment 26 provides the abrasive article of any one of Embodiments 24 or 25, wherein the aluminosilicate have an alumina to silica ratio in the range of about 60:40 to about 90:10 by weight.

Embodiment 27 provides the abrasive article of any one of Embodiments 24-26, wherein the aluminosilicate comprises from about 30 wt % to about 99.99 wt % alumina.

Embodiment 28 provides the abrasive article of any one of Embodiments 24-27, wherein the aluminosilicate comprises from about 30 wt % to about 80 wt % alumina.

Embodiment 29 provides the abrasive article of any one of Embodiments 24-28, wherein the metal comprises iron, gold, silver, platinum, zirconium, tungsten, molybdenum, titanium, tantalum, niobium, alloys thereof, or mixtures thereof.

Embodiment 30 provides the abrasive article of any one of Embodiments 1-29, further comprising a binder disposed throughout the web.

Embodiment 31 provides the abrasive article of Embodiment 30, wherein the binder comprises an inorganic binder, an organic binder, or mixtures thereof.

Embodiment 32 provides the abrasive article of any one of Embodiments 1-31, wherein the fibers are entangled, braided, woven, or a combination thereof, to form a mat.

Embodiment 33 provides the abrasive article of any one of Embodiments 1-32, wherein the fibers independently have a length in a range of from about 0.1 mm to about 500 mm.

Embodiment 34 provides the abrasive article of any one of Embodiments 1-33, wherein the fibers independently have a length in a range of from about 0.5 mm to about 25 mm.

Embodiment 35 provides the abrasive article of any one of Embodiments 1-34, wherein a density of the web is in a range of from about 0.05 g/cm³ to about 0.8 g/cm³.

Embodiment 36 provides the abrasive article of any one of Embodiments 1-35, wherein a basis weight of the web is in a range of from about 10 g/m² to about 200 g/m².

Embodiment 37 provides the abrasive article of any one of Embodiments 1-36, wherein the fibrous web comprises a non-woven web, a spun-bound non-woven web, a needle entangled non-woven web, a braided web, a knit web, a woven web, a blown microfiber, or a combination thereof.

Embodiment 38 provides the abrasive article of any one of Embodiments 1-37, wherein the fibrous web comprises a yarn comprising a plurality of the high-heat resistant fibers.

Embodiment 39 provides the abrasive article of any one of Embodiments 1-38, wherein the at least a portion of the plurality of fibers are bonded to each other, free of agglomeration with each other, or a combination thereof.

Embodiment 40 provides the abrasive article of any one of Embodiments 1-39, wherein the fibrous web comprises a first major surface and a second major surface spaced from the first surface.

Embodiment 41 provides the abrasive article of Embodiment 40, wherein the first major surface and the second major surface independently comprise a planar profile or an irregular profile.

Embodiment 42 provides the abrasive article of any one of Embodiments 40 or 41, wherein a portion of the plurality of shaped abrasive particles are located on the first major surface of the fibrous web.

Embodiment 43 provides the abrasive article of Embodiment 42, wherein the portion of the plurality of shaped abrasive particles located on the first major surface of the fibrous web is in a range of from about 50 wt % to about 100 wt % of the shaped abrasive particles.

Embodiment 44 provides the abrasive article of any one of Embodiments 42 or 43, wherein the portion of the plurality of shaped abrasive particles located on the first major surface of the fibrous web is in a range of from about 70 wt % to about 100 wt % of the shaped abrasive particles.

Embodiment 45 provides the abrasive article of any one of Embodiments 42-44, wherein a portion of the plurality of shaped abrasive particles are located in a range of from about 5% to about 100% of a thickness of the fibrous web measured from the first major surface and the second major surface.

Embodiment 46 provides the abrasive article of Embodiment 45, wherein the portion of the plurality of shaped abrasive particles that are located in a range of from about 5% to about 100% of a thickness of the fibrous web measured from the first major surface and the second major surface is in a range of from about 10 wt % to about 100 wt % of the shaped abrasive particles.

Embodiment 47 provides the abrasive article of any one of Embodiments 45 or 46, wherein the portion of the plurality of shaped abrasive particles that are located in a range of from about 5% to about 100% of a thickness of the fibrous web measured from the first major surface and the second major surface is in a range of from about 50 wt % to about 100 wt % of the shaped abrasive particles.

Embodiment 48 provides the abrasive article of any one of Embodiments 1-47, wherein at least one of the shaped abrasive particles of the plurality of shaped abrasive particles is tetrahedral and comprises four faces joined by six edges terminating at four tips, each one of the four faces contacting three of the four faces.

Embodiment 49 provides the abrasive article of Embodiment 48, wherein at least one of the four faces is substantially planar.

Embodiment 50 provides the abrasive article of any one of Embodiments 48 or 49, wherein at least one of the four faces is concave.

Embodiment 51 provides the abrasive article of Embodiment 48, wherein all of the four faces are concave.

Embodiment 52 provides the abrasive article of any one of Embodiments 48 or 50, wherein at least one of the four faces is convex.

Embodiment 53 provides the abrasive article of Embodiment 48, wherein all of the four faces are convex.

Embodiment 54 provides the abrasive article of any one of Embodiments 48-53, wherein at least one of the tetrahedral shaped abrasive particles has equally-sized edges.

Embodiment 55 provides the abrasive article of any one of Embodiments 48-54, wherein at least one of the tetrahedral shaped abrasive particles has different-sized edges.

Embodiment 56 provides the abrasive article of any one of Embodiments 1-55, wherein at least one of the shaped abrasive particles of the plurality of shaped abrasive particles comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

Embodiment 57 provides the abrasive article of Embodiment 56, further comprising at least one sidewall connecting the first side and the second side.

Embodiment 58 provides the abrasive article of Embodiment 57, wherein the at least one sidewall is a sloping sidewall.

Embodiment 59 provides the abrasive article of any one of Embodiments 57 or 58, wherein a draft angle α of the sloping sidewall is in a range of from about 95 degrees and about 130 degrees.

Embodiment 60 provides the abrasive article of any one of Embodiments 56-59, wherein the first face and the second face are substantially parallel to each other.

Embodiment 61 provides the abrasive article of any one of Embodiments 56-60, wherein the first face and the second face are substantially non-parallel to each other.

Embodiment 62 provides the abrasive article of any one of Embodiments 57-61, wherein at least one of the first and the second face are substantially planar.

Embodiment 63 provides the abrasive article of any one of Embodiments 57-62, wherein at least one of the first and the second face is a non-planar face.

Embodiment 64 provides the abrasive article of any one of Embodiments 1-63, wherein at least one of the shaped abrasive particles comprises at least one shape feature comprising: an opening, a concave surface, a convex surface, a groove, a ridge, a fractured surface, a low roundness factor, or a perimeter comprising one or more corner points having a sharp tip.

Embodiment 65 provides the abrasive article of any one of Embodiments 1-64, wherein a portion of the shaped abrasive particles form a predetermined pattern on the fibrous web.

Embodiment 66 provides the abrasive article of Embodiment 65, wherein the portion of the shaped abrasive particles that form a predetermined pattern are in a range of from about 25 wt % to about 100 wt % of the plurality of shaped abrasive particles.

Embodiment 67 provides the abrasive article of any one of Embodiments 65 or 66, wherein the portion of the shaped abrasive particles that form a predetermined pattern are in a range of from about 50 wt % to about 80 wt % of the plurality of shaped abrasive particles.

Embodiment 68 provides the abrasive article of any one of Embodiments 65-67, wherein the predetermined pattern comprises a plurality of circles.

Embodiment 69 provides the abrasive article of any one of Embodiments 65-68, wherein the predetermined pattern comprises a plurality of substantially parallel lines.

Embodiment 70 provides the abrasive article of any one of Embodiments 1-69, wherein a z-direction rotational angle about a line perpendicular to a major surface of the fibrous web and passing through individual shaped abrasive particles of the plurality of shaped abrasive particles is substantially the same for a portion of the plurality of shaped abrasive particles.

Embodiment 71 provides the abrasive article of Embodiment 65, wherein the portion of the shaped abrasive particles having substantially the same z-direction rotational angle are in a range of from about 25 wt % to about 100 wt % of the plurality of shaped abrasive particles.

Embodiment 72 provides the abrasive article of any one of Embodiments 70 or 71, wherein the portion of the shaped abrasive particles having substantially the same z-direction rotational angle are in a range of from about 50 wt % to about 80 wt % of the plurality of shaped abrasive particles.

Embodiment 73 provides the abrasive article of any one of Embodiments 1-72, wherein at least some of the plurality of shaped abrasive particles comprise a ceramic material.

Embodiment 74 provides the abrasive article of any one of Embodiments 1-73, wherein at least some of the plurality of shaped abrasive particles comprise alpha alumina, sol-gel derived alpha alumina, or a mixture thereof.

Embodiment 75 provides the abrasive article of any one of Embodiments 1-74, wherein at least some of the plurality of shaped abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 76 provides the abrasive article of any one of Embodiments 1-75, wherein at least one of the plurality of high-heat resistant fibers and at least one of the plurality of shaped abrasive particles comprise the same material or the same mixture of materials.

Embodiment 77 provides the abrasive article of any one of Embodiments 1-76, wherein at least one of the plurality of high-heat resistant fibers and at least one of the plurality of shaped abrasive particles comprise a different material or a different mixture of materials.

Embodiment 78 provides the abrasive article of any one of Embodiments 1-77, further comprising a plurality of crushed abrasive particles.

Embodiment 79 provides the abrasive article of Embodiment 65, wherein at least one of the plurality of crushed abrasive particles and at least one of the shaped abrasive particles comprise the same material or mixture of materials.

Embodiment 80 provides the abrasive article of any one of Embodiments 65-79, wherein at least one of the plurality of crushed abrasive particles and at least one of the shaped abrasive particles comprise a different material or mixture of materials.

Embodiment 81 provides the abrasive article of any one of Embodiments 65-80, wherein the plurality of shaped abrasive particles comprise about 5 wt % to about 95 wt % of a blend of the plurality of shaped abrasive particles and the plurality of crushed abrasive particles.

Embodiment 82 provides the abrasive article of any one of Embodiments 1-81, wherein the abrasive article is a non-woven abrasive article, a coated abrasive article, or a bonded abrasive article.

Embodiment 83 provides the abrasive article of any one of Embodiments 1-82, wherein the abrasive article comprises a belt, a wheel, or a sheet.

Embodiment 84 provides the abrasive article of any one of Embodiments 82 or 83, wherein the abrasive article further comprises flexible backing attached to the fibrous web.

Embodiment 85 provides the abrasive article of Embodiment 84, wherein the flexible backing comprises a polymeric film, a metal foil, a woven fabric, a knitted fabric, paper, a vulcanized fiber, a nonwoven, a foam, a screen, a laminate, or a combination thereof.

Embodiment 86 provides the abrasive article of any one of Embodiments 84 or 85, further comprising a make coat adhering the fibrous web to the backing.

Embodiment 87 provides the abrasive article of any one of Embodiments 84-86, further comprising a size coat adhering the plurality of shaped abrasive particles to the make coat.

Embodiment 88 provides the abrasive article of any one of Embodiments 84-87, wherein at least one of the make coat and the size coat comprise a phenolic resin, an epoxy resin, a urea-formaldehyde resin, an acrylate resin, an aminoplast resin, a melamine resin, an acrylated epoxy resin, a urethane resin, or a mixture thereof.

Embodiment 89 provides the abrasive article of any one of Embodiments 84-88, wherein at least one of the make coat and the size coat comprises a filler, a grinding aid, a wetting agent, a surfactant, a dye, a pigment, a coupling agent, an adhesion promoter, or a mixture thereof.

Embodiment 90 provides the abrasive article of Embodiment 89, wherein the filler comprises calcium carbonate, silica, talc, clay, calcium metasilicate, dolomite, aluminum sulfate, or a mixture thereof.

Embodiment 91 provides the abrasive article of any one of Embodiments 82-90, wherein the abrasive article is a bonded abrasive article comprising a binder at least partially encapsulating the fibrous web and the plurality of shaped abrasive particles.

Embodiment 92 provides the abrasive article of Embodiment 91, wherein the binder comprises an organic binder material, a vitrified binder material, or a metallic binder material.

Embodiment 93 provides the abrasive article of Embodiment 92, wherein the organic binder material comprises a phenolic resin.

Embodiment 94 provides the abrasive article of any one of Embodiments 1-93, wherein the plurality of high-heat resistant fibers and the plurality of shaped abrasive particles form a monolithic structure.

Embodiment 95 provides the abrasive article of any one of claims 1-94, wherein an amount of linear shrinkage in an individual shaped abrasive particle is substantially equal to an amount of linear shrinkage of an individual high-heat resistant fiber post firing.

Embodiment 96 provides a method of making the abrasive article of any one of Embodiments 1-95, the method comprising:

contacting the fibrous web with the plurality of shaped abrasive particles to form an abrasive article precursor; and

heating the abrasive article precursor to a temperature of at least about 800° C.

Embodiment 97 provides the method of Embodiment 96, wherein the abrasive article precursor is heated to a temperature of at least about 1000° C.

Embodiment 98 provides the method of any one of Embodiments 96 or 97, wherein the abrasive article precursor is heated to a temperature of at least about 1500° C.

Embodiment 99 provides the method of any one of Embodiments 96-98, wherein the abrasive article precursor is heated to a temperature of at least about 2000° C.

Embodiment 100 provides the method of any one of Embodiments 96-99, wherein the abrasive article precursor is heated to a temperature of at least about 2500° C.

Embodiment 101 provides the method of any one of Embodiments 96-100, wherein the abrasive article precursor is heated to a temperature in a range of from about 800° C. to about 2500° C.

Embodiment 102 provides the method of any one of Embodiments 96-101, wherein the abrasive article precursor is heated to a temperature in a range of from about 1000° C. to about 2000° C.

Embodiment 103 provides the method of Embodiment 96, wherein a make coat is disposed on at least one of the fibrous web and the plurality of shaped abrasive particles.

Embodiment 104 provides the method of any one of Embodiments 96-103, wherein each of the plurality of shaped abrasive particles are disposed in individual replicated cavities of a production tool.

Embodiment 105 provides the method of Embodiment 104, wherein a pattern of the individual replicated cavities corresponds to the predetermined pattern of the shaped abrasive particles.

Embodiment 106 provides the method of any one of Embodiments 104 or 105, further comprising forming the shaped abrasive particles in the individual cavities.

Embodiment 107 provides the method of Embodiment 106, wherein forming the shaped abrasive particles comprises:

contacting the individual cavities with a shaped abrasive particle precursor; and

heating the shaped abrasive particle precursor.

Embodiment 108 provides the method of Embodiment 107, wherein the shaped abrasive particle precursor is heated to a temperature in a range of from about 30° C. to about 150° C.

Embodiment 109 provides the method of any one of Embodiments 107 or 108, wherein the shaped abrasive particle precursor is heated to a temperature in a range of from about 30° C. to about 75° C.

Embodiment 110 provides the method of any one of Embodiments 96-109, further comprising contacting the fibrous web with the flexible backing.

Embodiment 111 provides the method of any one of Embodiments 96-110, further comprising at least partially encasing the fibrous web with a binder.

Embodiment 112 provides the method of any one of Embodiments 96-111, further comprising breaking the abrasive article into a plurality of segments.

Embodiment 113 provides a method of using the abrasive article of any one of Embodiments 1-95 or formed according to the method of any one of Embodiments 96-112, the method comprising:

contacting the abrasive article with a workpiece;

moving at least one of the abrasive article and the workpiece relative to each other; and

removing at least a portion of the workpiece.

Embodiment 114 provides the method of Embodiment 113, wherein the workpiece comprises steel, aluminum, alloys thereof, wood, or mixtures thereof.

1. An abrasive article, comprising:
a fibrous web comprising a plurality high-heat resistant fibers; and
a plurality of shaped abrasive particles attached to the fibrous web.

2. The abrasive article of claim 1, wherein the fibers independently comprises a ceramic, a metal, or a combination thereof.

3. The abrasive article of claim 1, wherein the fibers are independently heat resistant to a temperature of at least about 500° C.

4. The abrasive article of claim 1, wherein the fibers are independently heat resistant to a temperature in a range of from about 500° C. to about 2500° C.

5. The abrasive article of claim 2, wherein the ceramic is chosen from an aluminosilicate, an alumina, a silica, a silicon carbide, a silicon nitride, a carbon, a glass, an alumina-phosphorous pentoxide, an alumina-boria-silica, a zirconia, a zirconia-alumina, a zirconia-silica, a sol gel, Al₂O₃, and mixtures thereof.

6. The abrasive article of claim 2, wherein the ceramic is Al₂O₃.

7. The abrasive article of claim 1, wherein the fibers independently have a length in a range of from about 0.1 mm to about 500 mm.

8. The abrasive article of claim 1, wherein at least one of the shaped abrasive particles of the plurality of shaped abrasive particles is tetrahedral and comprises four faces joined by six edges terminating at four tips, each one of the four faces contacting three of the four faces.

9. The abrasive article of claim 1, wherein at least one of the shaped abrasive particles of the plurality of shaped abrasive particles comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

10. The abrasive article of claim 1, wherein at least some of the plurality of shaped abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

11. A method of making an abrasive article, the method comprising:
contacting a fibrous web with a plurality of shaped abrasive particles, or precursors thereof, to form an abrasive article precursor; and
heating the abrasive article precursor to a temperature of at least about 500° C., wherein the fibrous web comprises a plurality high-heat resistant fibers.

12. The method of claim 11, wherein the abrasive article precursor is heated to a temperature in a range of from about 800° C. to about 2500° C.

13. The method of claim 11, wherein each of the plurality of shaped abrasive particles are disposed in individual replicated cavities of a production tool.

14. The method of claim 11, further comprising contacting the fibrous web with a flexible backing.

15. The method of claim 11, wherein the abrasive article precursor is sintered.
